(19) United States
(12) Patent Application Publication
(10) Pub. No.: US 2004/0153444 A1
(43) Pub. Date: Aug. 5, 2004

(54) Technique for effectively providing search results by an information assistance service

(76) Inventors: Steven L. Senders, Portland, OR (US); David W. Camarillo, Beaverton, OR (US)

Correspondence Address: Alex L. Yip, Kaye Scholer LLP, 425 Park Avenue, New York, NY, 10022, US

(21) Appl. No.: 10/360,479

(22) Filed: Feb. 7, 2003

Related U.S. Application Data
(60) Provisional application No. 60/443,739, filed on Jan. 30, 2003.

(51) Int. Cl. G06F 7/00

(52) U.S. Cl. 707/3

(57) ABSTRACT

In an information assistance system, database records are searched for search results that are exact matches or potential matches with the search request. Matches are identified based upon a confidence measure that is generated for each search result. The confidence measure relates to the likelihood that a responsive record contains the information desired by a user. Each search result of an information assistance search output is then sorted and displayed based upon the relative confidence measure of each search result, from, for example, highest confidence measure to lowest. In accordance with an aspect of the invention, a maximum limit and/or minimum limit may be instituted to control the search output. For example, the search output may not be revealed or displayed if the number of search results does not meet the maximum/minimum limit requirement.

This application claims, under 35 U.S.C. § 119(e), the benefit of U.S. Provisional Application Serial No. _________, filed Jan. 30, 2003.

### FIELD OF THE INVENTION

The invention relates to a communications system and method, and more particularly to a system and method for sorting and displaying information assistance search results.

### BACKGROUND OF THE INVENTION

It is a common experience to use a telephone, such as a wireless or wireline telephone, to call an operator or automated directory assistance service for directory assistance. In a typical directory assistance call, a caller identifies to the operator or service the name and address (e.g., city and state) of a party whose telephone number is desired. In response, the operator or service locates the desired destination number by, for example, accessing and searching a computer database. The destination number is then provided to the caller by, for example, the operator or a computerized voice server which provides automated voicing of the number.

With existing directory assistance methods and systems, search request results are often listed in alphabetical order—based on, for example, the last name and first name of a desired party or the name of a business or other desired entity—or some other order without considering the relative reliability of each search result. Although an alphabetical listing may be an organized way of displaying directory assistance search results, such search results are not sorted and listed in a manner that considers the likelihood that a given search result contains information relating to a desired party.

In addition, existing directory assistance systems and methods typically limit search results output to exact or close to exact matches with respect to the input received from a user. Although this abridged output tends to facilitate review of the search results as compared to a longer listing of search results, such an output often limits the number of search results that is responsive to a given request, and in some instances omits potential search results respecting a search request.

### SUMMARY OF THE INVENTION

The above-described technique of sorting and displaying directory assistance search results has proven to be ineffective, stemming from its failure to provide a thorough set of potential directory assistance search results. In addition, the above-described technique fails to consider the likelihood that a given output's search result contains the information sought by a user.

Thus, in accordance with an embodiment of the invention, information assistance search results that include a complete list of exact matches and potential matches with the received search request data, having a confidence measure greater than a predetermined threshold, are sorted and displayed to a user. A confidence measure is a value (e.g., a numeric range of 0-100) that is associated with each searched information assistance record that is responsive to a search request, and relates to the likelihood that a responsive record contains the information desired by a user. Each search result of an information assistance search output is then sorted and displayed in descending order, by associated confidence measure, as compared to each of the other search results.

This is accomplished by receiving search request data relating to a search for which information is desired. The search request data is then parsed data field by data field, and a search for records that match or potentially match the search request is performed. Each data field component of a return record (e.g., desired party's name, city/town, state, etc.) responsive to the search request is assigned a confidence weight value, as a function of a likelihood that the data field component of the return record corresponds to that of the search request. A confidence measure for the return record is derived from the confidence weight values associated with the respective data field components therein. The return record is ordered and listed, among other return records, based upon its confidence measure relative to those of the others.

In accordance with an aspect of the invention, the number of return records may be compared with a selected limit, e.g., a maximum limit and/or a minimum limit, before they are revealed. For example, the return records may not be revealed if the number thereof exceeds the selected maximum limit. Similarly, the return records may not be revealed if the number thereof is below the selected minimum limit. In either event, the search may return a status message, indicating that the search result does not meet the limit requirement.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates an example of search output of a conventional directory assistance system;

FIG. 2 illustrates an example of an information assistance search output in accordance with an embodiment of the invention;

FIG. 3 illustrates an information assistance system in accordance with an embodiment of the invention;

FIG. 4 is a flowchart depicting a routine for sorting and displaying information assistance search results in accordance with an embodiment of the invention;

FIG. 5 is a flowchart depicting a routine for imposing a limit on the search results to control a search output;

FIG. 6 illustrates an example of data fields that may be considered in a search in accordance with an embodiment of the invention; and

FIG. 7 illustrates an information assistance system in accordance with a second embodiment of the invention.

### DETAILED DESCRIPTION

The invention is directed to a system and method for evaluating, sorting and displaying information assistance search results by an information assistance service. A conventional technique for providing information assistance search results is listing search request results in alphabetical order—based on, for example, the last name and first name of a desired party or the name of a business or other desired entity—or some other order without considering the relative confidence as to whether a given search result contains the information desired by the user. In addition, conventional directory assistance searching techniques typically limit search results output to exact or close to exact matches with respect to the input received from a user.

In accordance with an embodiment of the invention, information assistance search results that include exact matches and potential matches, as compared with received search request data, are sorted and displayed to a user. Potential matches include search results that have an associated confidence measure which is greater than a predetermined threshold. Specifically, a confidence measure is associated with each uncovered information assistance record that is responsive to a search request, and relates to the likelihood that a responsive record contains the information desired by a user. Each search result of an information assistance search output is then sorted and displayed in order, by associated confidence measure, as compared to each of the other search results.

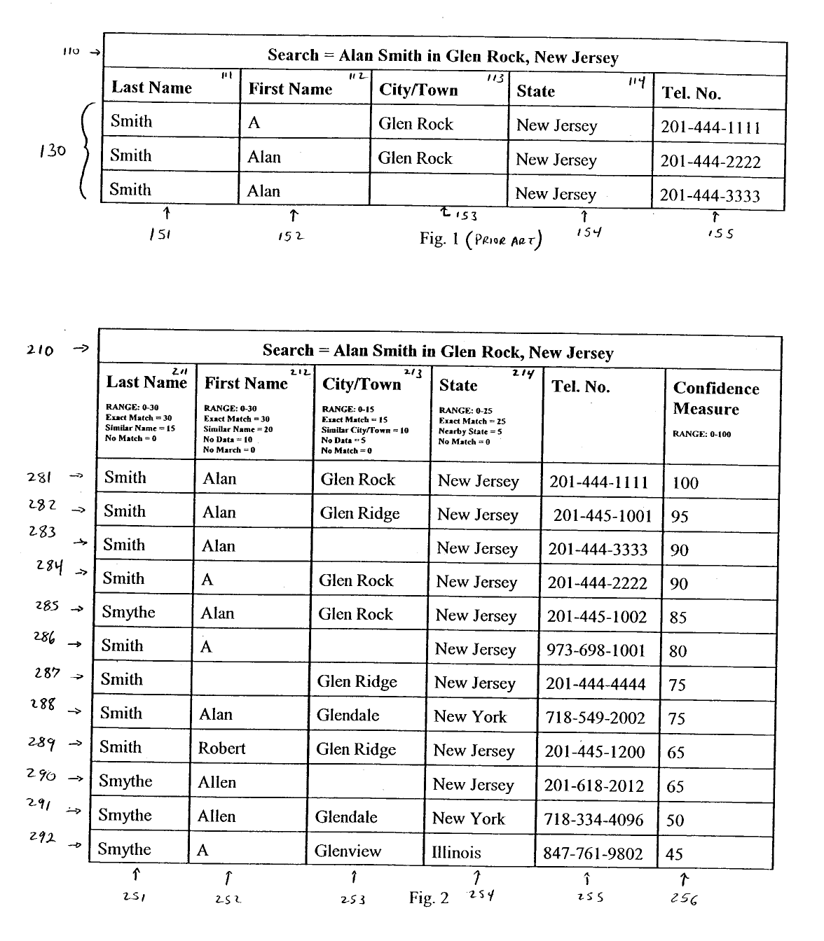

An example of a prior art directory assistance search request and resultant search result output is illustrated in FIG. 1. The search request, in this example, is provided in row 110 and is characterized by a search for a party named Alan Smith residing in Glen Rock, N.J. Upon receiving such information, a directory assistance operator typically parses the search request into data fields (i.e., desired party's Last Name (111), First Name (112), City/Town (113), State (114)). Thus, the search request may be parsed such that a party's telephone number is searched wherein the party has the first name “Alan,” has the last name “Smith,” and resides in the town of “Glen Rock” which is located in the state of “New Jersey.”

Search output responsive to the above search request is denoted by output 130 of FIG. 1. Output 130 includes listings that include exact or almost exact matches to the search request. In this instance, because two search results bearing the name “Alan Smith” in “Glen Rock, N.J.” and one search result bearing the name “A. Smith” in “Glen Rock N.J.” match or substantially match the search request data, telephone numbers associated with these three parties are provided (column 155). In addition, last name information (column 151), first name information (column 152), city/town information (column 153) and state information (column 154) are included in the directory assistance search output.

Further, the search results are typically listed in strict alphabetical order based upon one or more of search result data fields 111-114.

An example of search output, in accordance with an embodiment of the invention, is illustrated in FIG. 2. In this example, the search request (which is the same as the request used in FIG. 1) is provided in row 210 and is characterized by a search for a party named Alan Smith in Glen Rock, N.J. The search request may then be parsed such that a matching party telephone number is searched for a party having the first name “Alan,” the last name “Smith,” residing in the city/town of “Glen Rock” which is located in the state of “New Jersey.”

When a search is performed, in accordance with an embodiment of the invention, using the aforesaid search query data, listings are provided that include potential matches to the search request data. Potential matches include search results or listings that have an associated confidence measure which meets or exceeds a predetermined threshold.

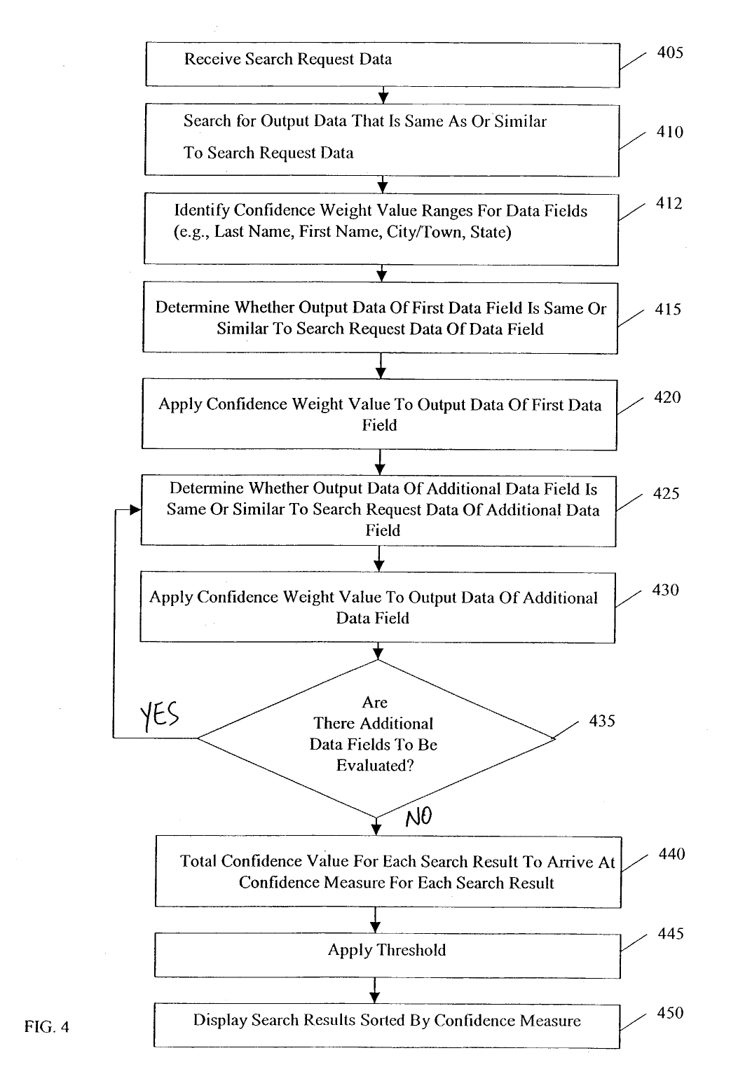

In this example, 12 potentially matching search results (as shown by rows 281-292) relating to a desired party are found with a confidence measure that meets or exceeds the predetermined threshold—e.g., 45. The search results include the following party information for a potentially matching search result: last name information (column 251), first name information (column 252), city/town information (column 253), state information (column 254) and telephone number information (column 255). In addition, the search results include a confidence measure (in column 256) resulting from a comparison between search request data and a responsive search result, on a data field by data field basis. The confidence measure indicates the likelihood that a search result contains the information that is sought by the user. In addition to evaluating the likelihood of whether a search result includes the desired information, the confidence measure, in accordance with an embodiment of the invention, dictates the order in which search results are displayed. The methodology for generating the confidence measure is fully described below with reference to FIG. 4.

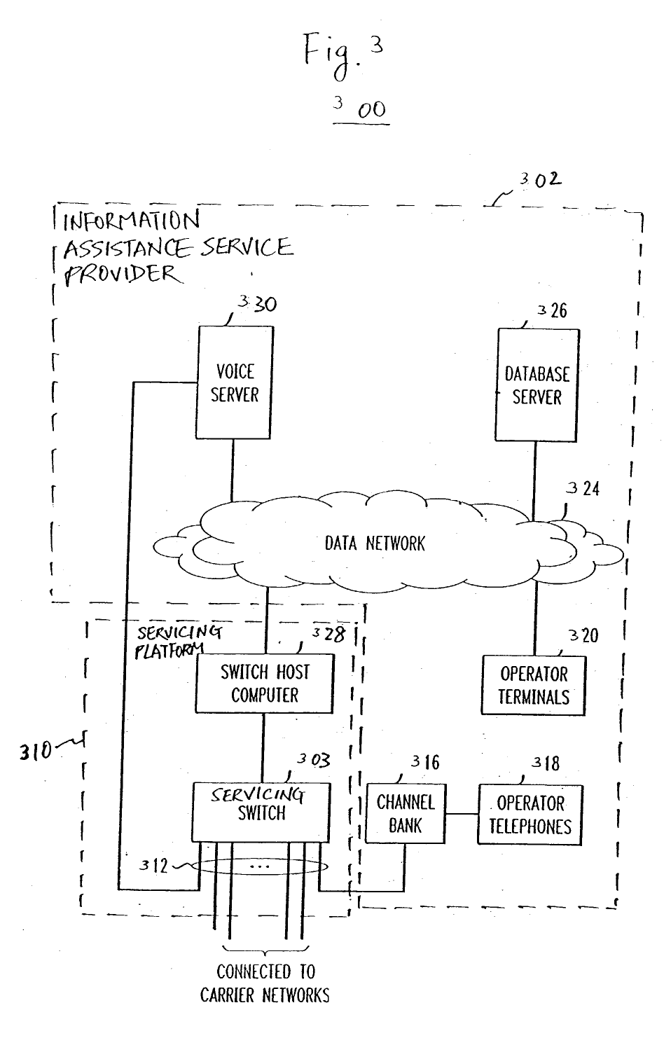

FIG. 3 illustrates information assistance system 300 embodying the principles of the invention. In this illustrative embodiment, users of a particular telephone carrier may dial, speak or otherwise communicate predetermined access digits, access codes or retail numbers, or input a predetermined address or URL established by the carrier to access information assistance service provider 302. For example, the predetermined access digits may be “411,” “*555,” “555-1212,” “00,” etc. Upon learning one such access digit sequence initiated from a user's communications device, a switching system of the user's telephone carrier in a conventional manner routes the information assistance call to provider 302 through servicing platform 310.

It should be noted that even though both provider 302 and servicing platform 310 appear in the same figure, they may or may not be located in the same geographic area. In FIG. 3, servicing platform 310 comprises servicing switch 303 having T1 spans 312 for connection to voice server 330, channel bank 316, and carrier networks. Switch 303 may receive an incoming information assistance call from one of the carrier networks through a carrier switch therein. It may also be used to place an outgoing call through one of the carrier networks which may be different than that used for the incoming call.

Channel bank 316 in provider 302 is used to couple multiple operator telephones 318 to switch 303. The operators in system 300 are further equipped with operator terminals 320, each of which includes a video display unit and a keyboard with associated dialing pad. Operator terminals 320 are connected over data network 324 to one or more database server(s) 326 (although only one is shown here). Switch host computer 328 and voice server 330 are also connected to data network 324. By way of example, data network 324 includes a local area network (LAN) supplemented by a number of point-to-point data links. Through data network 324 and routers (not shown), components of system 300, may also be connected to the Internet.

Switch 303 is conventional and supports digital T1 connectivity. The operation of switch 303 is governed by instructions stored in switch host computer 328. In this illustrative embodiment, switch 303 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on system 300 and switch 303 for each corresponding function.

An incoming information assistance call from a user is received by switch 303 in system 300 which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 328 or elsewhere in system 300. In other instances, other distribution logic schemes may be utilized, such as skills-based routing or a priority scheme for preferred users.

Operators may utilize database server 326 to provide information assistance including searching for information concerning a user's desired party and determining the appropriate destination telephone number of the party. Other information assistance concerning restaurant recommendations, movie listings, events, etc. may also be provided by searching database server 326.

Voice server 330 is used to play the constant repeated parts of an operator's speech, namely, the various greetings and signoffs (or closings). Voice server 330 is connected via data network 324 to switch host computer 328 and via one or more T1 spans to switch 303. Voice server 330 may comprise a general purpose computer and one or more voice cards for voice recognition, voice recording and playback, and call progress analysis. At appropriate stages in a call progression, switch host computer 328 initiates a voice path connection between voice server 330 and switch 303 such that the user, or the user and the operator, are able to hear whatever pre-recorded speech is played on that connection by voice server 330. Computer 328 then instructs voice server 330, via data network 324, what type of message to play, and passes data parameters that enable voice server 330 to locate the message appropriate to the call state.

By way of example, suppose the user in the instant information assistance call is seeking information concerning the destination telephone number of a desired party. The operator who answers the call may elicit from the user the name and location of the party for which the desire telephone number is sought—for instance, Alan Smith of Glen Rock, N.J. The operator then uses, e.g., database server 326, to search databases (not shown) for listings of exact matches as well as potential matches in accordance with an embodiment of the invention. To that end, database server 326 is programmed to identify search results that are responsive to the user's search request—i.e., records that are exact matches or potential matches with the search request.

FIG. 4 illustrates a routine used by server 326 for identifying search results in accordance with an embodiment of the invention. At step 405, search request data is received by database server 326, e.g., from an operator. Server 326 then searches one or more databases (not shown) for records that are responsive to the search request (step 410). Server 326 searches for all records that contain data which is an exact match or a potential match with the desired party in accordance with the invention. A record is considered an exact match when the data in each data field of the search request—such as last name, first name, city/town and state—is the same as those of the corresponding data field in the record. Records that are considered potential matches here are those records that, although not exact matches, are likely responsive to the search request based on an evaluation of data in the respective data fields in a manner described below.

In this illustrative embodiment, server 326 has a conventional string-evaluation capability for determining whether names (i.e., first name, last name, city/town name, name of state, etc.) in searched records are similar in spelling and/or similar in sound or pronunciation, as compared to those names in a search request. In addition, server 326 has access to map data to identify the distance between a city/town or state included in a search request as compared to city/town or state location information of a record that is searched for a respective data field. Thus, for example, two cities may be considered similar if the city names are similar in spelling, sound and/or pronunciation, or if the locations of cities are within a predetermined distance, such as 35 miles of one another.

Returning to step 410, server 326 searches for exact search data, as well as similar data, for each data field for potential responsive records as described above.

At step 412, confidence weight value ranges for data fields 211-214 are identified. In accordance with an embodiment of the invention, the highest total confidence measure for a responsive listing record—which is an exact match—is 100, but the confidence weight value range for a given data field varies and depends on the number and type of data fields that are to be searched for a given request. For instance, in the example provided in FIG. 2, where a search includes Last Name data field 211, First Name data field 212, City/Town data field 213 and State data field 214, the confidence weight value ranges for these fields, in accordance with an aspect of the invention, are 0-30, 0-30, 0-15, and 0-25, respectively.

For each responsive record, database server 326 then determines, at step 415, whether responsive data of the Last Name data field 211 is the same or similar to the data of field 211 of the search request, and depending on whether an exact match is found, similar match is found, no match is found, or whether no data is included in field 211 in the record, an appropriate confidence weight value is applied for field 211 (step 420).

Thus, for example, where the data for a given data field of a search request is an exact match with the data of the corresponding data field of a responsive record, the highest confidence weight value of the associated range is applied. Alternatively, where the data for a given data field of a search request is not an exact match and is not similar to the data of a respective data field of a responsive record, the lowest confidence measure of the associated range—i.e., 0—is applied.

Where, however, the data for a given data field of a search request is similar to the data of the corresponding data field of a responsive record, a confidence weight value between the highest value and the lowest value of the associated range is applied. Thus, referring to FIG. 2, in accordance with an embodiment of the invention, an exact match between the last name of a search request and the last name of a responsive record results in a confidence weight value of 30, a similar match (e.g., similar spelling or similar sounding name) results in a confidence weight value of 15, and no match or similarity in last name results in a confidence weight value of 0. An exact match in first name results in a confidence weight value of 30, a similar match (e.g., similar spelling or similar sounding name) results in a confidence weight value of 20, and no match or similarity in the first name results in a confidence weight value of 0. It should be noted that in certain data fields, such as the First Name data field 212, where a responsive record contains no data at all for that field, a confidence weight value may nevertheless be assigned—such as, in this example, a confidence weight value of 10.

In accordance with an embodiment of the invention, an exact match between the city/town name of a search request and the city/town name of a responsive record results in a confidence weight value of 15, and no match or similarity in city/town name results in a confidence weight value of 0. A similar match in city/town name results in a confidence weight value of 10 if a similar spelling or sounding of the city/town name is located, and a similar match in city/town name also results in a confidence weight value of 10 if the city or town data of a responsive record relates to a city/town that is within a predetermined distance from the city/town name that is included in the search request. If a responsive record contains no data at all for a city/town name, a confidence weight value, such as 5, is applied for this data field. An exact match for state name results in a confidence weight value of 25, and no match or similarity in state name results in a confidence weight value of 0. A similar match respecting a state results in a confidence weight value of 5 if the state that is located in a responsive record is within a threshold distance (e.g., 30 miles) from the state that is included in the search request.

In another embodiment, the weight value may be based on a sliding scale depending on the actual distance between the located and requested places (city/town, state) relative to a threshold distance. For example:

Confidence Weight Value(City/Town and/or State)=Actual Distance/Threshold Distance×Range Value

In accordance with an embodiment of the invention, the highest weight value of the ranges for the searched fields (i.e., an exact match) totals 100. Thus, the confidence measure for an exact match, as calculated by database server 326, results in a total of 100. Where an exact match is found for each data field (as shown in row 281 of FIG. 2), the confidence weight value corresponding to each searched data field is as follows: First Name(Alan)=30, Last Name (Smith)=30, City/Town(Glen Rock)=15, and State(New Jersey)=25. As a result, the confidence measure equals 100 in this instance in accordance with the following expression:

Confidence Measure=Total Of Confidence Weight Values=30+30+15+25=100

In addition, where a match is similar (e.g., row 289), the confidence measure is less than 100: same Last Name (Smith)=30, different First Name (Robert)=0, similar City/Town (Glen Ridge)=10 and same State (New Jersey)=25, resulting in a total of 65.

It should be noted that the confidence measure determination depends on the weight value range for each of the data fields, which is determined by server 326, and depends on the number and types of data fields that are searched as a result of a search request. Thus, referring to the search illustrated in FIG. 2, matches respecting the desired party's last name and first name may be as high as 60 in confidence weight value (i.e., Last Name data field 211 is valued up to 30 and First Name data field 212 is also valued up to 30), whereas the city/town name and state information may only be as high as 40 (i.e., City/Town data field 213 is valued up to 15 and State data field 214 is valued up to 25). Thus, it will be appreciated that the actual upper range values vary with the significance that a person skilled in the art places on the individual fields.

At step 425, for each responsive record, server 326 determines whether responsive data of the next data field (e.g., first name data) is the same or similar to the First Name data field 212 of the search request. Depending on whether an exact match is found, similar match is found, no match is found, or whether no data is included in the record for this data field, the appropriate weight value (as described above) is applied, in this example, to the First Name data field 212 (step 430).

Server 326 then determines whether additional data fields remain for confidence weight value evaluation (step 435). If additional data fields are to be evaluated, such as fields 213 and 214, then the confidence weight value for these fields are determined and applied (steps 425 and 430). This process continues until all of the fields for which searches were performed have been evaluated for appropriate confidence weight value.

Once all of the fields have been evaluated for appropriate confidence weight value, a total confidence measure is determined for each record (step 440). This is accomplished, in an accordance with an embodiment of the invention, by totaling the confidence weight values for each data field of a search result record. A predesignated threshold respecting the confidence measure, such as 45, is then applied (step 450) thereby eliminating responsive records that do not have at least a certain baseline likelihood (e.g., 45 or higher) of having a potential match. The output results are then sorted by confidence measure (in descending order) and are displayed (step 450).

Thus, as described above, the responsive records illustrated in rows 281 and 289 have confidence measures equaling 100 and 65, respectively. Because these records are not less than the 45 threshold, they remain in the search output. In addition, because the record illustrated in row 281 has a higher confidence measure (100) than the record illustrated in row 289 (65), the record illustrated in row 281 is displayed before the record illustrated in row 289.

In accordance with an aspect of the invention, the search output may not be displayed or revealed if the responsive records in the search output does not meet a limit requirement. In an illustrative embodiment, a selected maximum limit is instituted such that the search output may not be revealed if the number of responsive records in the search output exceeds the selected maximum limit. The maximum limit may vary with the vagueness of the type of search request peculiar to a particular business purpose. Similarly, a selected minimum limit may be instituted such that the search output may not be revealed if the number of responsive records in the search output is below the selected minimum limit. Such a minimum limit requirement may stem from using the search output to populate a database requiring at least a certain number of responsive records. To that end, for example, after a search request is received by database server 326, the latter may request an input of the aforementioned maximum limit and/or minimum limit to control the search output. Alternatively, server 326 is programmed to enforce the maximum and/or minimum limit previously communicated thereto, especially when the limit does not vary from one request to another. Before the search output is revealed (e.g., before step 450), the number of responsive records in the search output is compared with any maximum limit, as indicated at step 503 in FIG. 5. If the number exceeds any such maximum limit, server 326 at step 505 causes a display of a status message, indicating that the search output does not meet the limit requirement. Otherwise, the routine proceeds from step 503 to step 509 where server 326 determines whether the number of responsive records in the search output is below any minimum limit. If the number is below any such minimum limit, the routine returns to step 505 described before. Otherwise, the routine proceeds to step 511 (analogous to step 450) where server 326 causes a display of the search output.

The foregoing merely illustrates the principles of the invention. It will thus be appreciated that those skilled in the art will be able to devise numerous other arrangements which embody the principles of the invention and are thus within its spirit and scope.

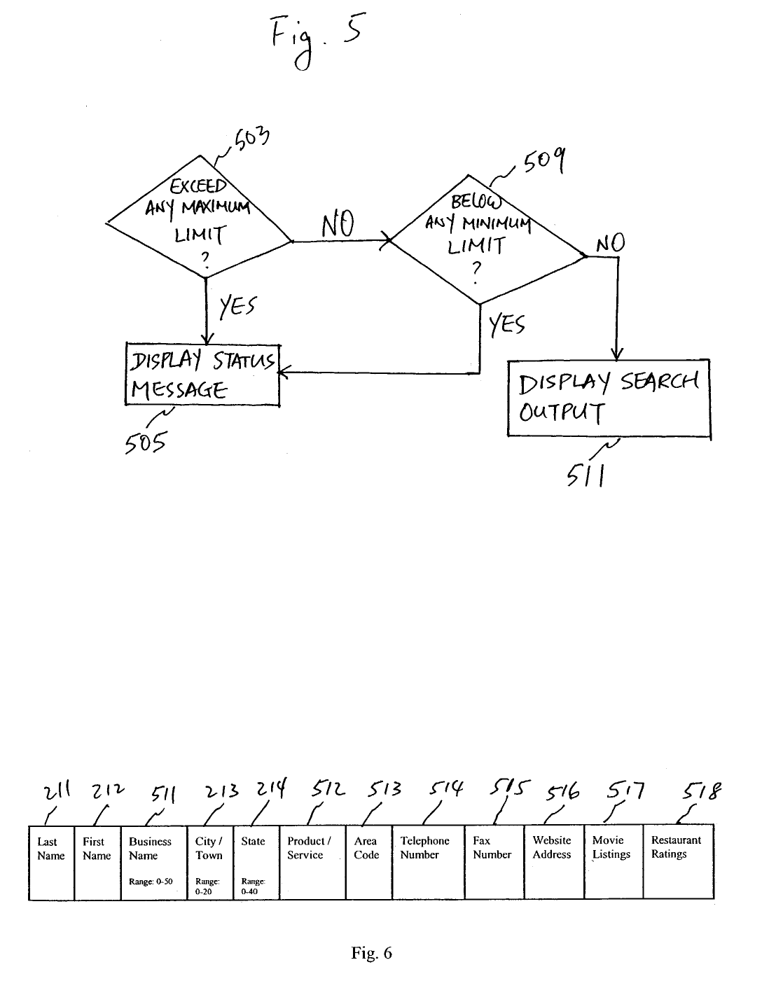

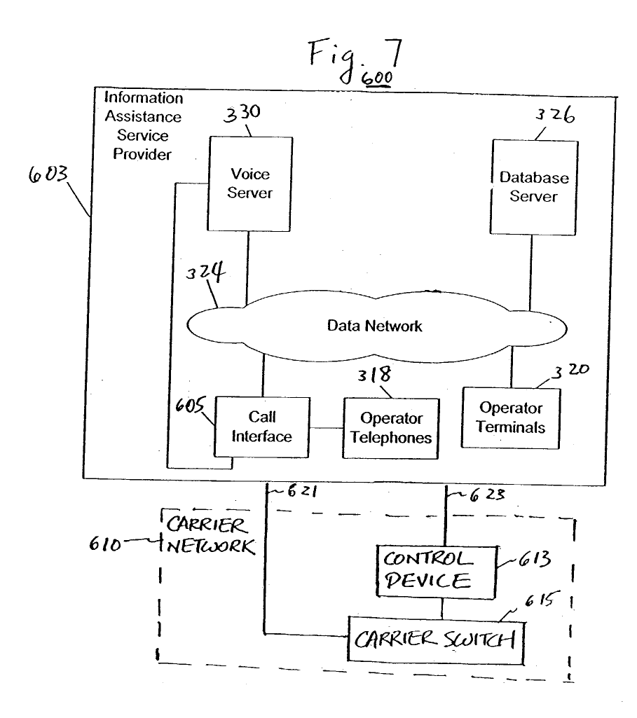

For instance, in the search request example provided above, search request data relating to a desired party's last name, first name, city/town and state was provided and the party's telephone number was sought. Accordingly, server 326 searched Last Name data field 211, First Name data field 212, City/State data field 213 and State data field 214. As illustrated in FIG. 6, other data fields may be used to effectuate the search. For example, searches may also be performed using a Business Name data field 511, Product/Service data field 512, Area Code data field 513, Telephone Number data field 514, Fax Number data field 515, Website Address data field 516, Movie Listings data field 517, Restaurant Ratings data field 518, etc. Thus, if a user submits a search request seeking information relating to movies playing at the Sony Theaters in Paramus, N.J., server 326 searches for listings which have field 511 containing a business name that is identical or similar to Sony Theaters, field 213 containing a city/town that is identical or similar (in spelling and/or sound) to Paramus, or that is within a predetermined distance of Paramus, and data field 214 containing a state that is identical or similar to New Jersey, or that is within a predetermined distance of New Jersey. Data relating to responsive listings are then sought from data field 517, and the uncovered listings are presented based on their confidence measures, computed similarly to those of the directory listings described above. The listings are then presented in an order based on the confidence measures.

In addition, the confidence measure information is not limited to the example provided above. Thus, the total confidence measure need not be calculated and displayed, but may be in the form of some other number (e.g., integer, decimal, etc.), percentage, letter rating (A, B, C, etc.), symbols (+, −, ×, check mark, etc.), and the like. Moreover, the confidence weight value ranges for a given data field may vary and the resulting confidence measure may exceed 100.

Further, the invention equally applies regardless of whether feature group D (FGD) type signaling, SS7 out-of-band signaling or other signaling is used for communications between carrier switches and switch 303 of FIG. 3.

In addition, information assistance system 300 may be configured differently from the configuration of FIG. 3. FIG. 7 illustrates an alternative information assistance system configuration. As shown in FIG. 7, the alternative system (denoted 600) has call interface 605 in information assistance service provider, which is no longer connected to servicing platform 310. The functionality of platform 310 principally is carried out in carrier network 610 in the alternative system. In fact, control device 613 in network 610 performs similar functions to switch host computer 328, and carrier switch 615 performs not only its conventional carrier switching functions, but also those of servicing switch 303 described before, under control of device 613. In this alternative system, an information assistance call is recognized by control device 613 when it is routed through carrier switch 615. Device 613 causes the information assistance call to be connected through one of pre-designated direct inward dial (DID) connections 621 to provider 603, which is received by call interface 605 therein. Interface 605, connected to operator telephones 318, includes the aforementioned ACD logic for distributing the call to an. operator at one of telephones 318 in a conventional manner. In the event that the information assistance call needs to be connected to a desired destination number, the operator causes the destination number and a “call completion” command to be transmitted to control device 613 via Internet connection 623. In response, control device 613 instructs switch 615 to connect the instant information assistance call to the received destination number. As per the instructions, switch 615 completes the call to the destination number.

Finally, information assistance systems 300 and 600 are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing information assistance, comprising:
receiving a request for information, the request containing at least first data component and second data component;
searching a database having a plurality of records in response to the request;
locating at least first and second records responsive to the request, the first and second records each having at least first and second data fields;
determining a first value indicative of a likelihood that content of the first data field of the first record relates to the first data component, a second value indicative of a likelihood that content of the second data field of the first record relates to the second data component, a third value indicative of a likelihood that content of the first data field of the second record relates to the first data component, and a fourth value indicative of a likelihood that content of the second data field of the second record relates to the second data component;
deriving a first measure associated with the first record from the first value and the second value, and a second measure associated with the second record from the third value and the fourth value; and
presenting the first record and the second record in an order based on the first and second measures associated therewith.

2. The method of claim 1, wherein the likelihood that content of the first data field of the first record relates to the first data component is based upon whether the content of the first data field is the same or similar to the first data component.

3. The method of claim 2, wherein the first data component relates to a name of a desired party.

4. The method of claim 2, wherein the first data component relates to a location of a desired party.

5. The method of claim 3, wherein the first data component relating to the name of the desired party is similar to the content of the first data field of the first record, if the first data field of the first record includes desired party name data that is spelled similarly to the first data component relating to the name of the desired party.

6. The method of claim 3, wherein the first data component relating to the name of the desired party is similar to the content of the first data field of the first record, if the first data field of the first record includes desired party name data that sounds similar to the first data component relating to the name of the desired party.

7. The method of claim 3, wherein the first data component relating to the location of the desired party is similar to the content of the first data field of the first record, if the first data field of the first record includes desired party location data that is spelled similarly to the first data component relating to the location of the desired party.

8. The method of claim 3, wherein the first data component relating to the location of the desired party is similar to the content of the first data field of the first record, if the first data field of the first record includes desired party location data that sounds similar to the first data component relating to the location of the desired party.

9. The method of claim 3, wherein the first data component relating to the location of the desired party is similar to the content of the first data field of the first record, if the first data field of the first record includes desired party location data of a first location that is within a predetermined distance of a second location which is identified by the desired party location information of the first data component.

10. The method of claim 1, wherein the information relates to a telephone number of a desired party.

11. The method of claim 1, wherein the information relates to a product or service offered by a desired party.

12. The method of claim 1, wherein the information relates to an area code of a desired party.

13. The method of claim 1, wherein the information relates to a fax number of a desired party.

14. The method of claim 1, wherein the information relates to a website address of a desired party.

15. The method of claim 1, wherein the information relates to movie information.

16. The method of claim 1, wherein the information relates to restaurant ratings.

17. A system for providing information assistance, comprising:
an interface for receiving a request for information, the request containing at least first data component and second data component;
a processor for searching a database having a plurality of records in response to the request, for locating at least first and second records responsive to the request, the first and second records each having at least first and second data fields, for determining a first value indicative of a likelihood that content of the first data field of the first record relates to the first data component, a second value indicative of a likelihood that content of the second data field of the first record relates to the second data component, a third value indicative of a likelihood that content of the first data field of the second record relates to the first data component, and a fourth value indicative of a likelihood that content of the second data field of the second record relates to the second data component, and for deriving a first measure associated with the first record from the first value and the second value, and a second measure associated with the second record from the third value and the fourth value; and
a mechanism for presenting the first record and the second record in an order based on the first and second measures associated therewith.

18. The system of claim 17, wherein the likelihood that content of the first data field of the first record relates to the first data component is based upon whether the content of the first data field is the same or similar to the first data component.

19. The system of claim 18, wherein the first data component relates to a name of a desired party.

20. The system of claim 18, wherein the first data component relates to a location of a desired party.

21. The system of claim 19, wherein the first data component relating to the name of the desired party is similar to the content of the first data field of the first record, if the first data field of the first record includes desired party name data that is spelled similarly to the first data component relating to the name of the desired party.

22. The system of claim 19, wherein the first data component relating to the name of the desired party is similar to the content of the first data field of the first record, if the first data field of the first record includes desired party name data that sounds similar to the first data component relating to the name of the desired party.

23. The system of claim 19, wherein the first data component relating to the location of the desired party is similar to the content of the first data field of the first record, if the first data field of the first record includes desired party location data that is spelled similarly to the first data component relating to the location of the desired party.

24. The system of claim 19, wherein the first data component relating to the location of the desired party is similar to the content of the first data field of the first record, if the first data field of the first record includes desired party location data that sounds similar to the first data component relating to the location of the desired party.

25. The system of claim 19, wherein the first data component relating to the location of the desired party is similar to the content of the first data field of the first record, if the first data field of the first record includes desired party location data of a first location that is within a predetermined distance of a second location which is identified by the desired party location information of the first data component.

26. The system of claim 17, wherein the information relates to a telephone number of a desired party.

27. The system of claim 17, wherein the information relates to a product or service offered by a desired party.

28. The system of claim 17, wherein the information relates to an area code of a desired party.

29. The system of claim 17, wherein the information relates to a fax number of a desired party.

30. The system of claim 17, wherein the information relates to a website address of a desired party.

31. The system of claim 17, wherein the information relates to movie information.

32. The system of claim 17, wherein the information relates to restaurant ratings.

33. A method for providing information assistance, comprising:
receiving a request for information;
searching a database having a plurality of records in response to the request;
determining confidence measures associated with one or more records responsive to the request;
comparing the number of responsive records with a selected limit, which have the associated confidence measures above a predetermined threshold; and
if the number does not meet a requirement based on the selected limit, none of the responsive records is revealed.

34. The method of claim 33, wherein the selected limit includes a maximum limit.

35. The method of claim 33, wherein the selected limit includes a minimum limit.

36. The method of claim 33, wherein if the number does not meet the requirement, a status message is provided, indicating that the requirement is not met.

37. The method of claim 33, wherein the information relates to a telephone number of a desired party.

38. The method of claim 33, wherein the information relates to a product or service offered by a desired party.
